(19) United States
(12) Patent Application Publication
(10) Pub. No.: US 2010/0216438 A1
(43) Pub. Date: Aug. 26, 2010

(54) MOBILE PHONE NUMBER EXCHANGE SYSTEM

(76) Inventors: Jim Ruttler, Seattle, WA (US); Heath Shaffer, Kent, WA (US); Jackie Edwards, Kent, WA (US)

Correspondence Address: Ruttler IP Law PLLC;One Union Square, 600 University Street, Suite 1919, Seattle, WA, 98101, US

(21) Appl. No.: 12/694,046

(22) Filed: Jan. 26, 2010

Related U.S. Application Data
(60) Provisional application No. 61/147,469, filed on Jan. 26, 2009.
(60) Provisional application No. 61/156,870, filed on Mar. 2, 2009.

(51) Int. Cl. H04W 4/00

(52) U.S. Cl. 455/414.1

(57) ABSTRACT

This invention relates generally to computers, and more specifically, to systems and methods for providing a mobile phone number exchange system. In one embodiment, the invention includes operations of receiving a contact name from a requesting entity; identifying the contact name in a data source; obtaining permission to disclose contact information associated with the contact name with the requesting entity; and upon receiving permission, disclosing the contact information associated with the contact name with the requesting entity, wherein the method is performed by computer executable instructions embodied in computer readable media.

### PRIORITY CLAIM

This application claims the benefit of U.S. provisional patent application Ser. No. 61/147,469 filed Jan. 26, 2009 (our ref. RTLR-1-1001) and U.S. provisional patent application Ser. No. 61/156,870 filed Mar. 2, 2009 (our ref. RTLR-1-1002). The foregoing applications are incorporated by reference in their entirety as if fully set forth herein.

### FIELD OF THE INVENTION

This invention relates generally to computers, and more specifically, to systems and methods for providing a mobile phone number exchange system.

### SUMMARY

This invention relates generally to computers, and more specifically, to systems and methods for providing a mobile phone number exchange system. In one embodiment, the invention includes operations of receiving a contact name from a requesting entity; identifying the contact name in a data source; obtaining permission to disclose contact information associated with the contact name with the requesting entity; and upon receiving permission, disclosing the contact information associated with the contact name with the requesting entity, wherein the method is performed by computer executable instructions embodied in computer readable media.

### BRIEF DESCRIPTION OF THE DRAWINGS

Embodiments of the present invention are described in detail below with reference to the following drawings:

FIGS. 1-19 are flow diagrams for providing a mobile phone number exchange system, in accordance with various embodiments of the invention;

FIGS. 20-28 are interfaces of a software application for providing a mobile phone number exchange system, in accordance with various embodiments of the invention; and

APPENDIX A includes disclosure of various alternative embodiments of the invention.

### DETAILED DESCRIPTION

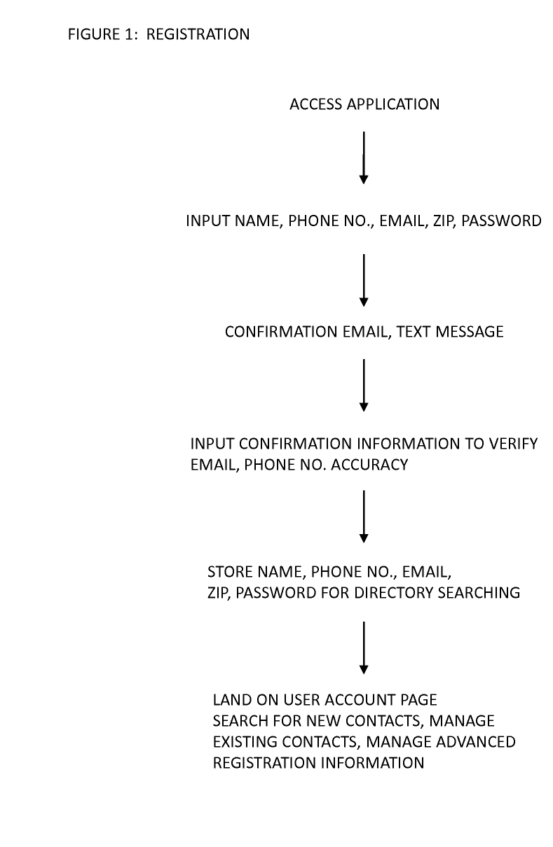

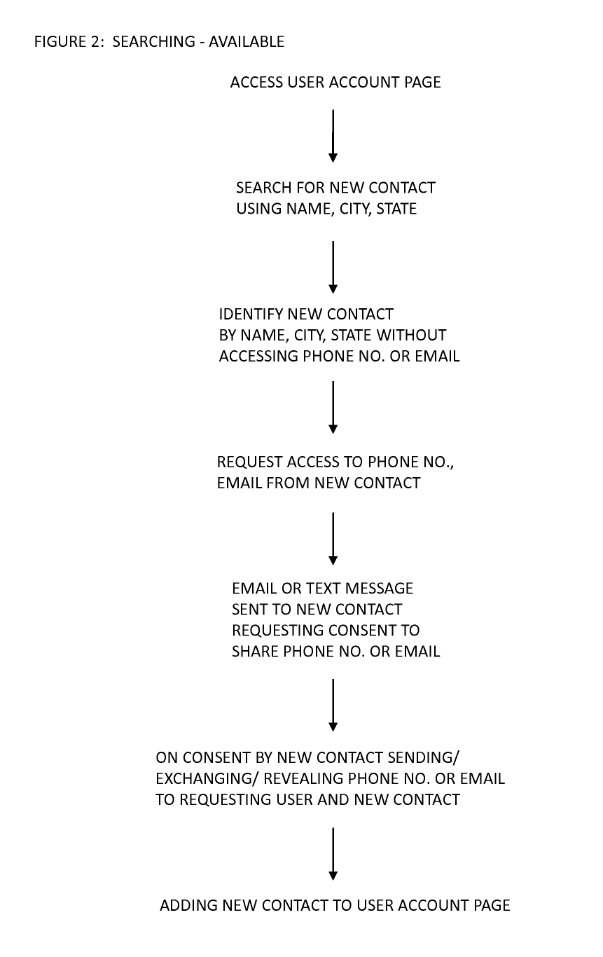

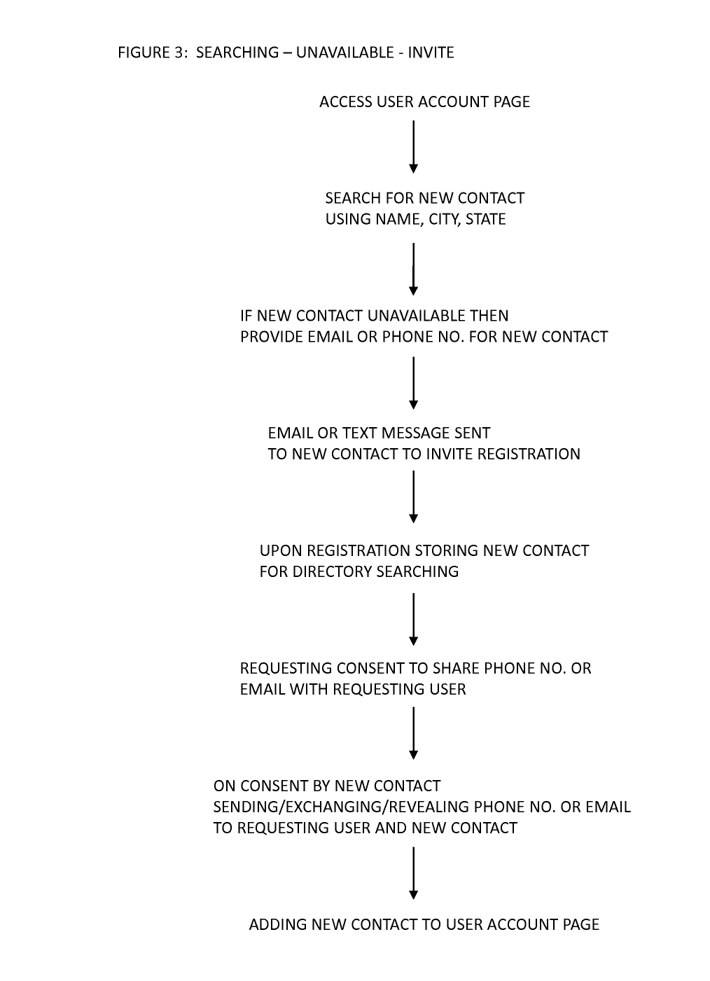

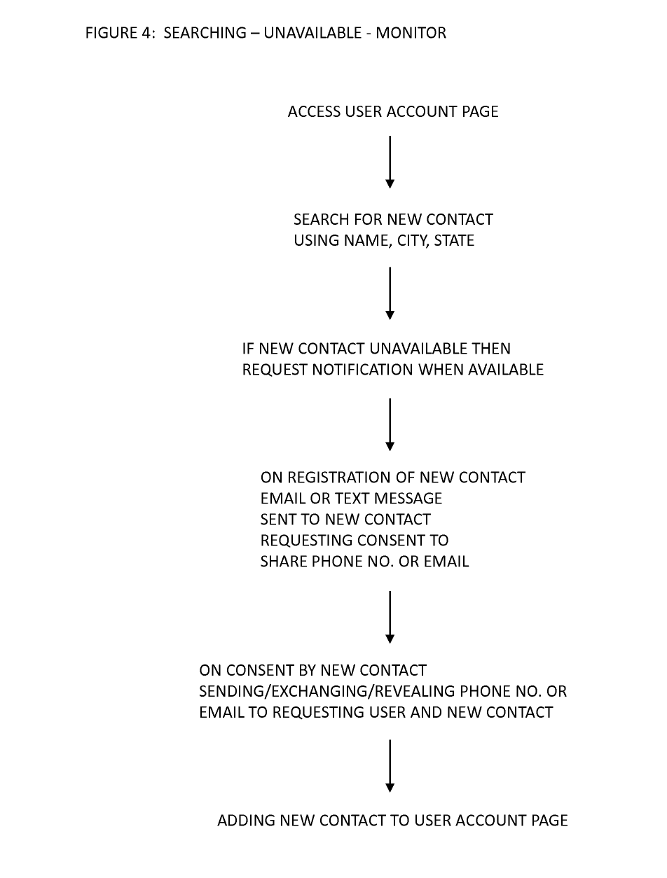

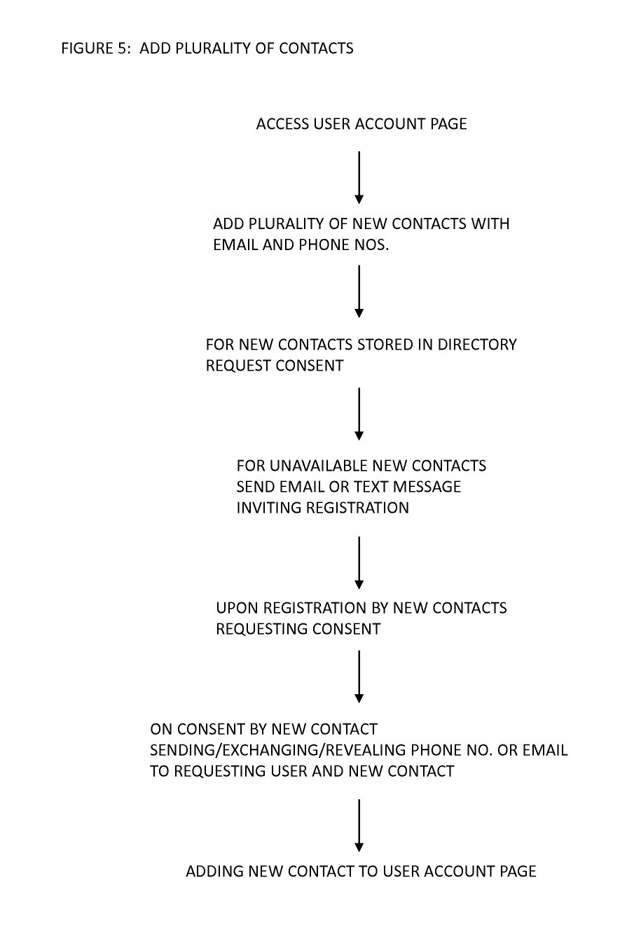

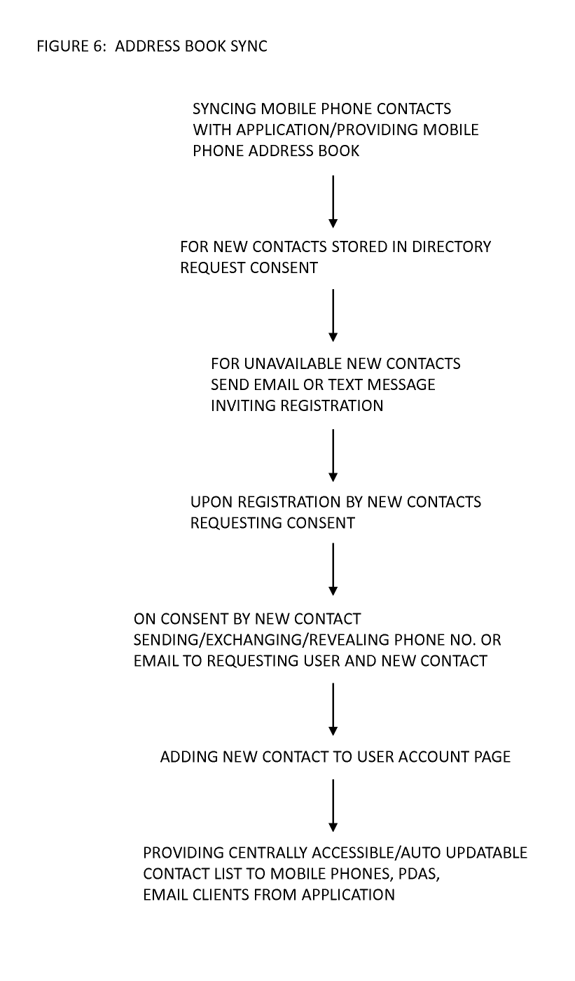

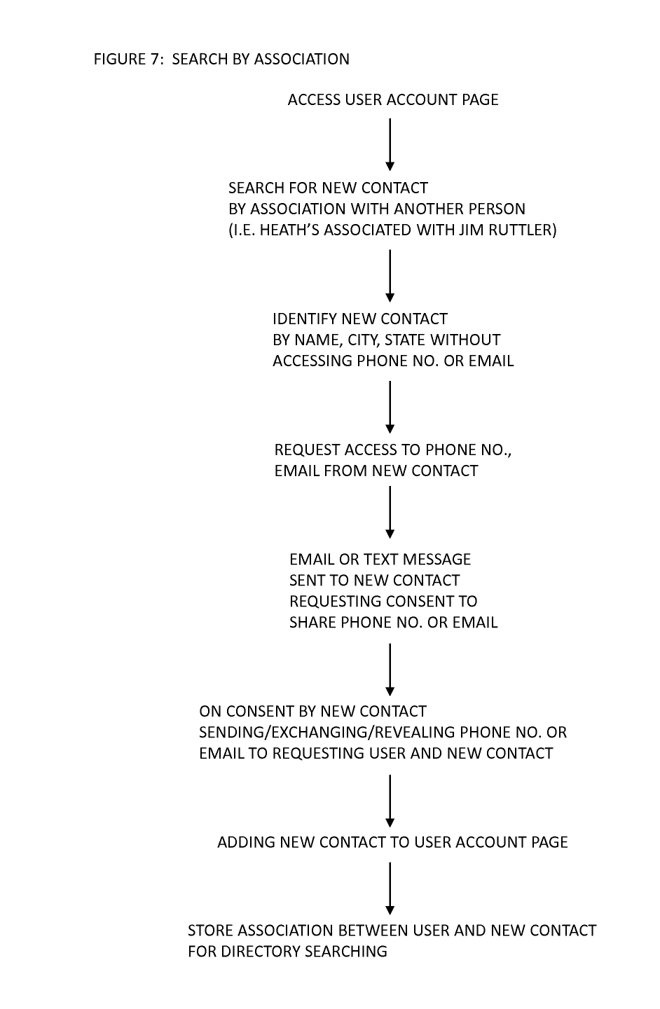

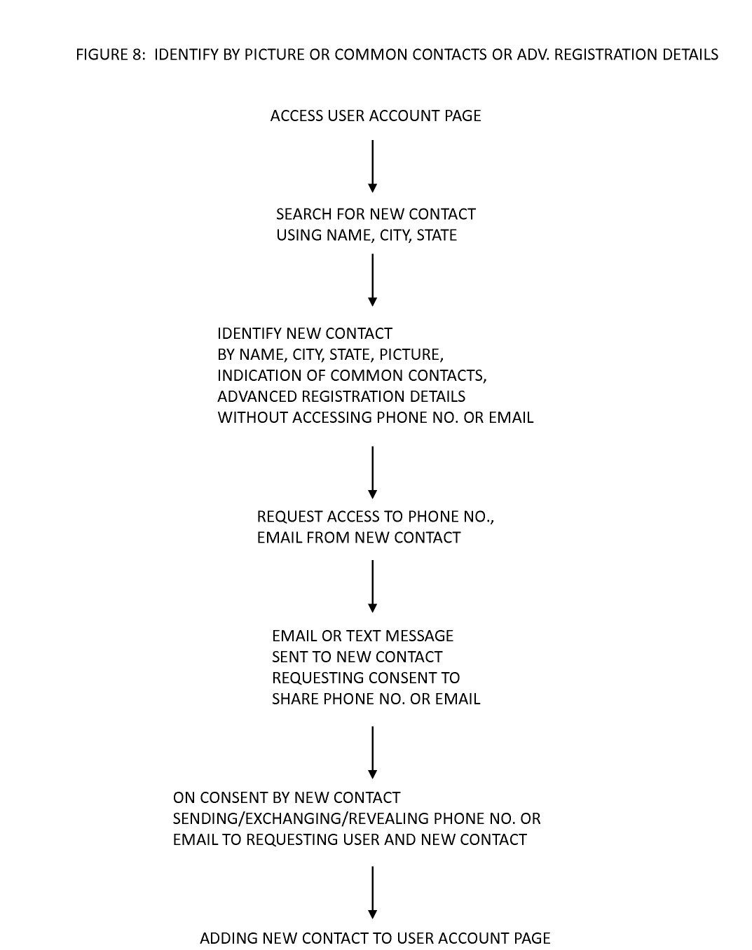

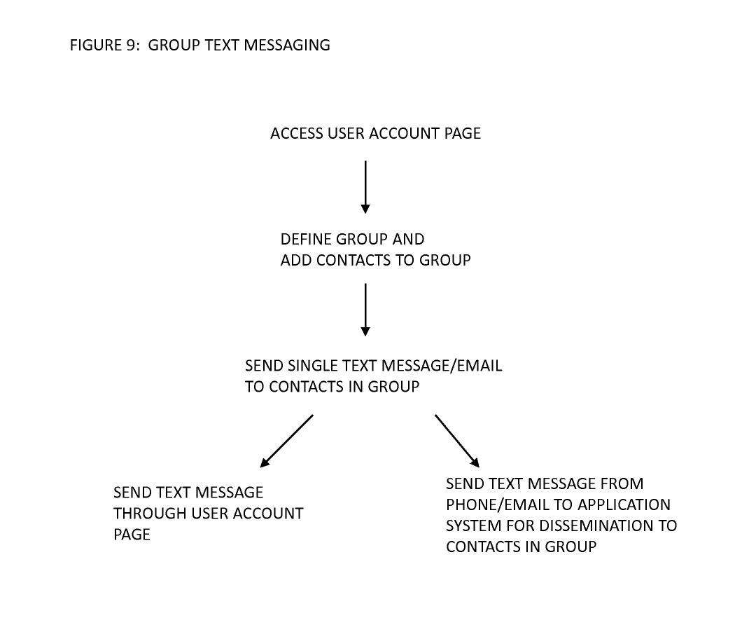

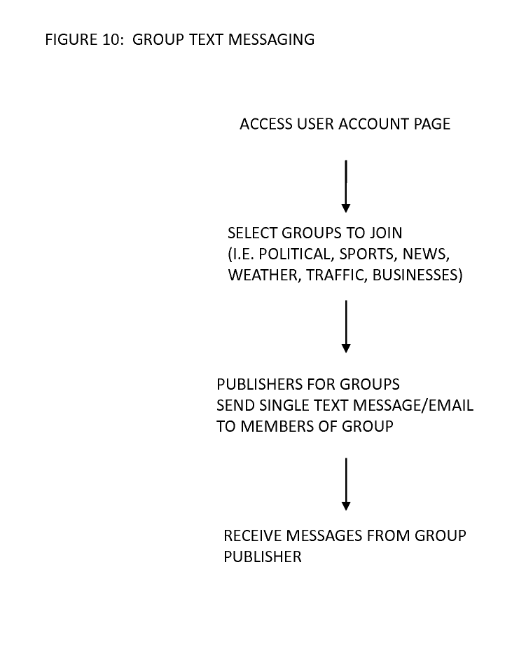

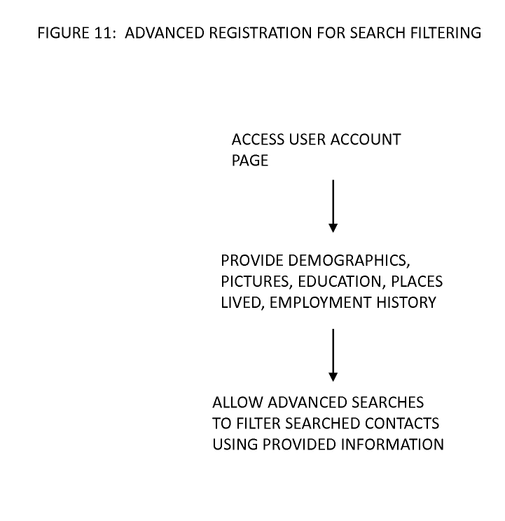

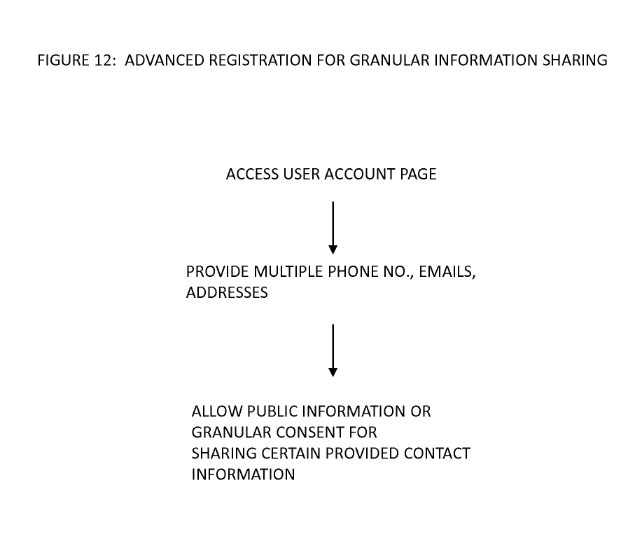

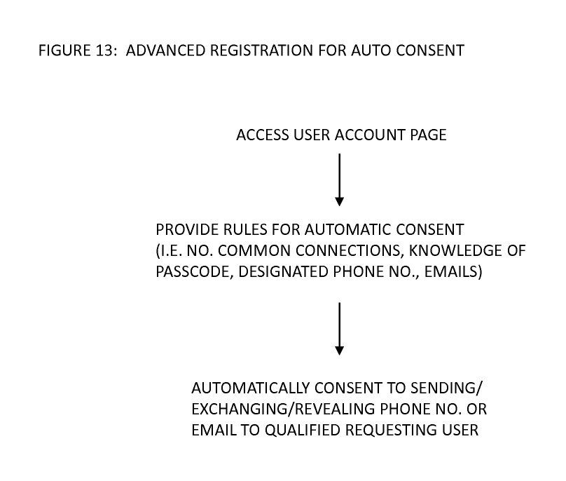

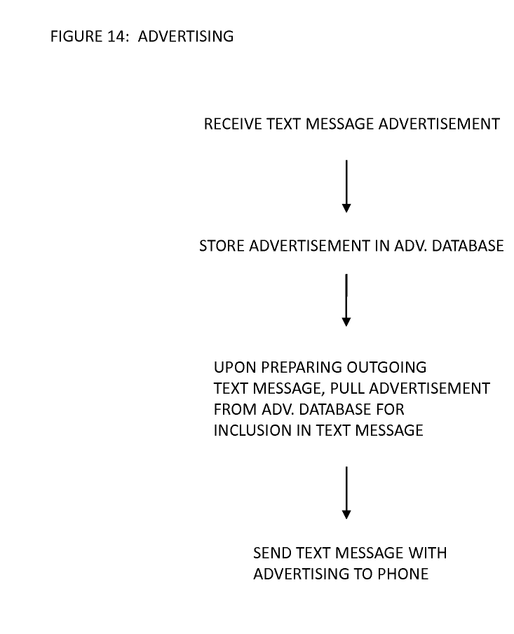

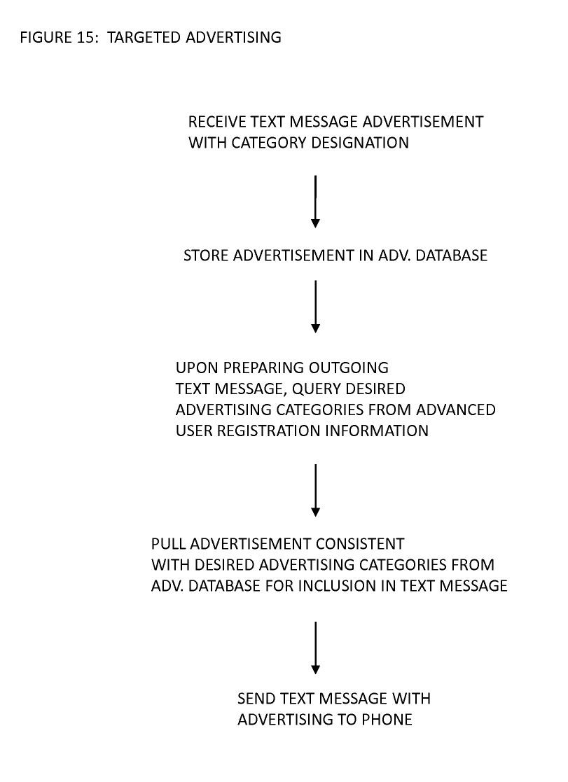

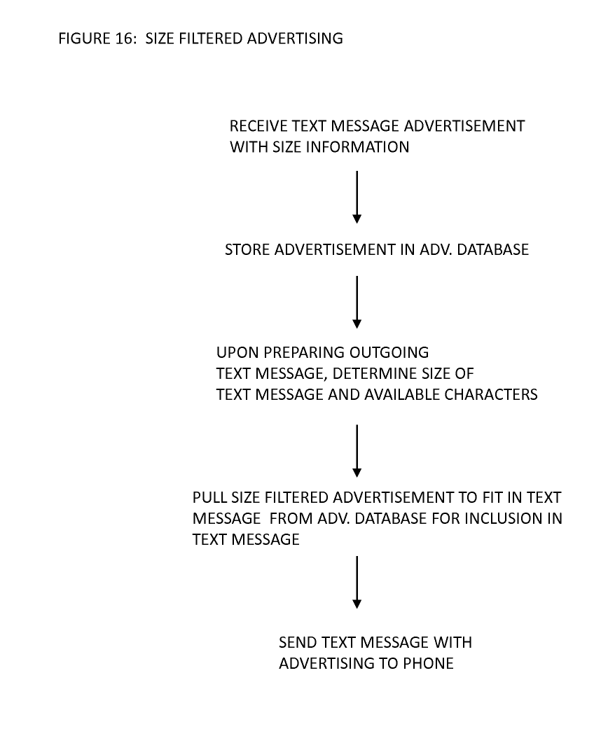

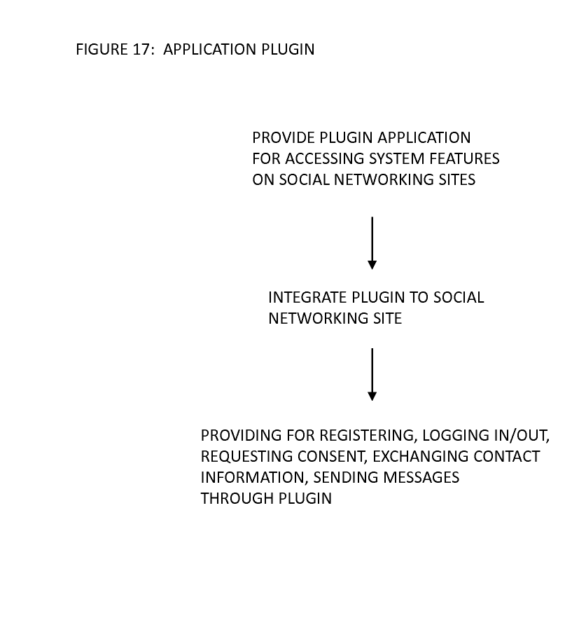

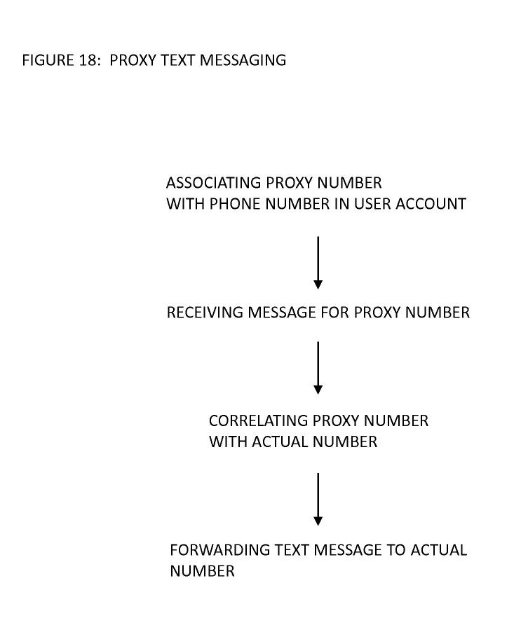

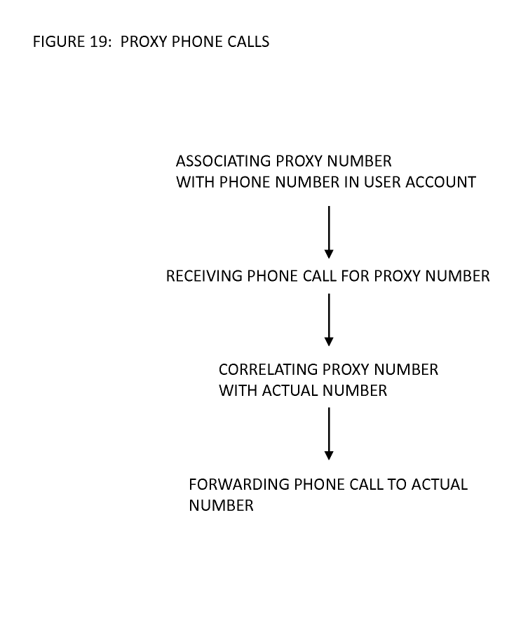

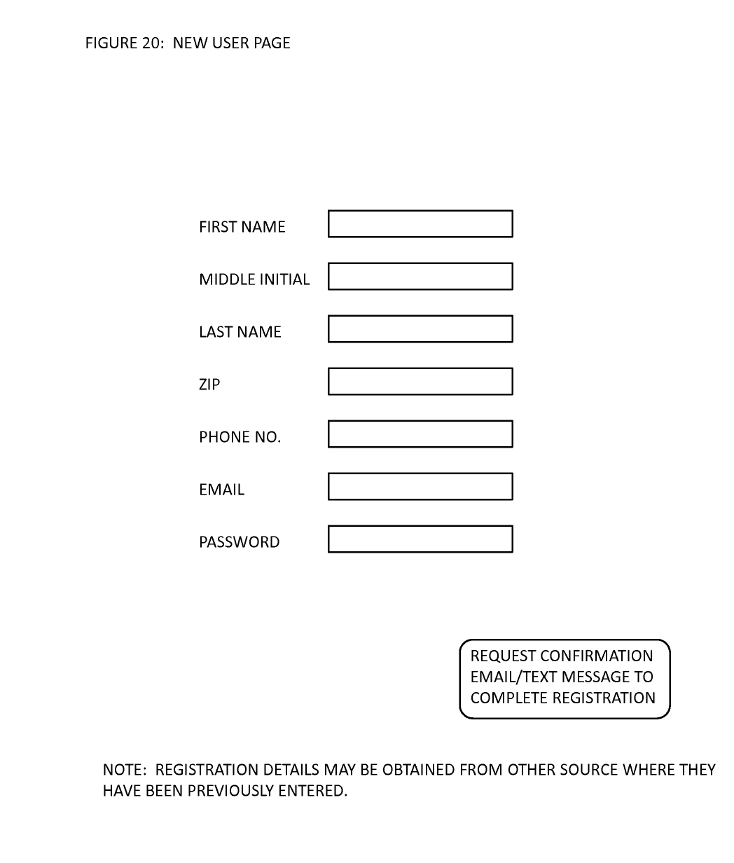

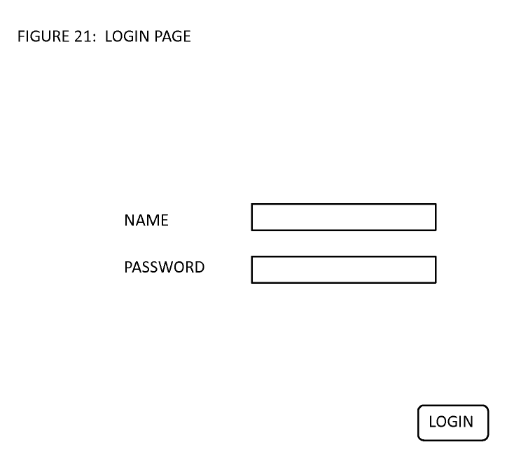

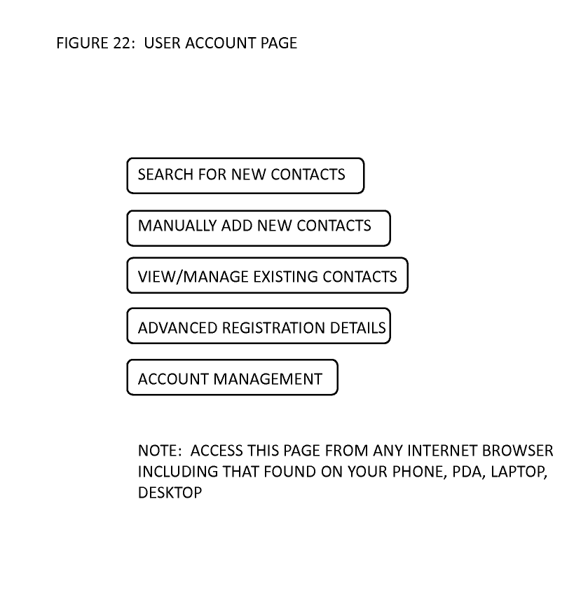

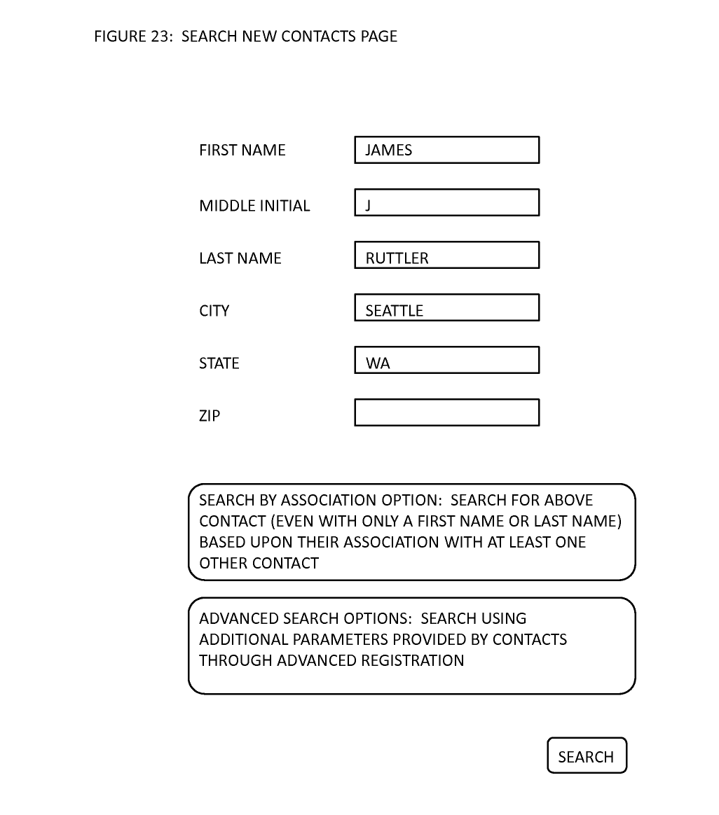

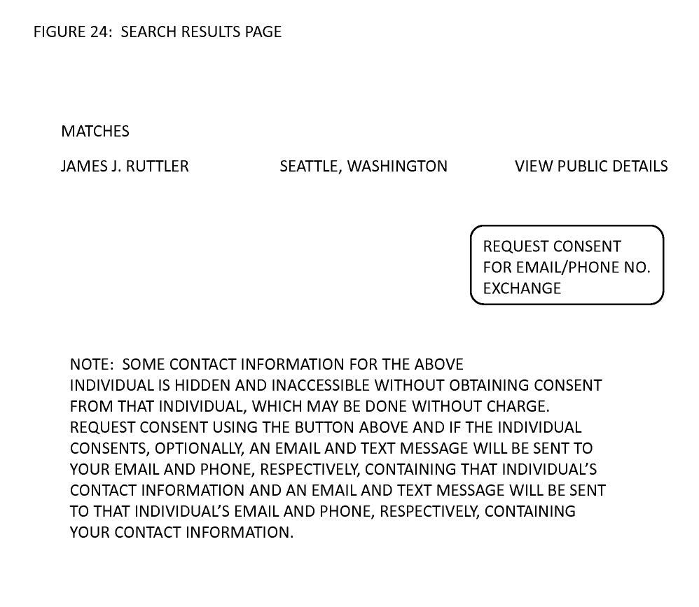

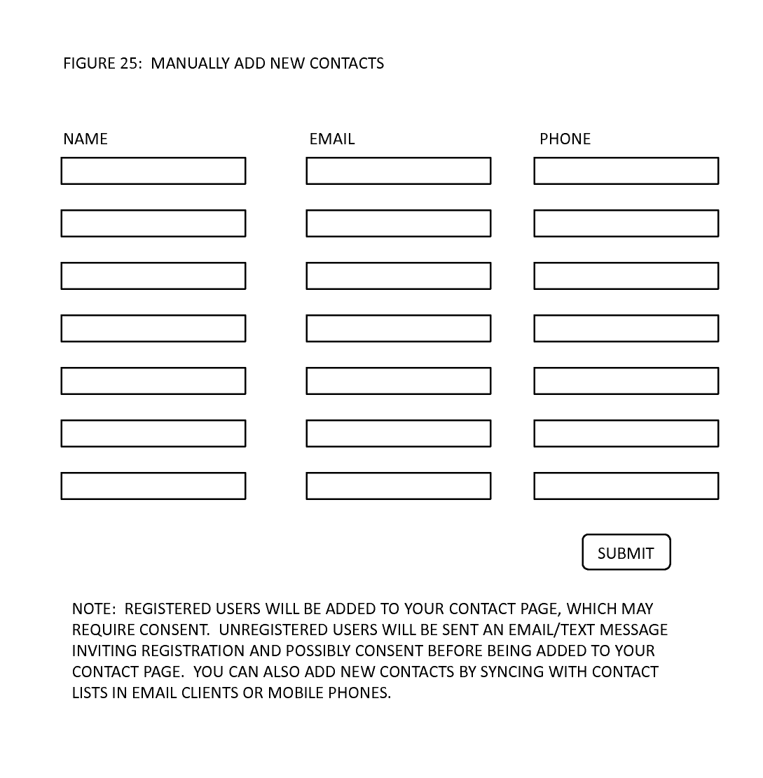

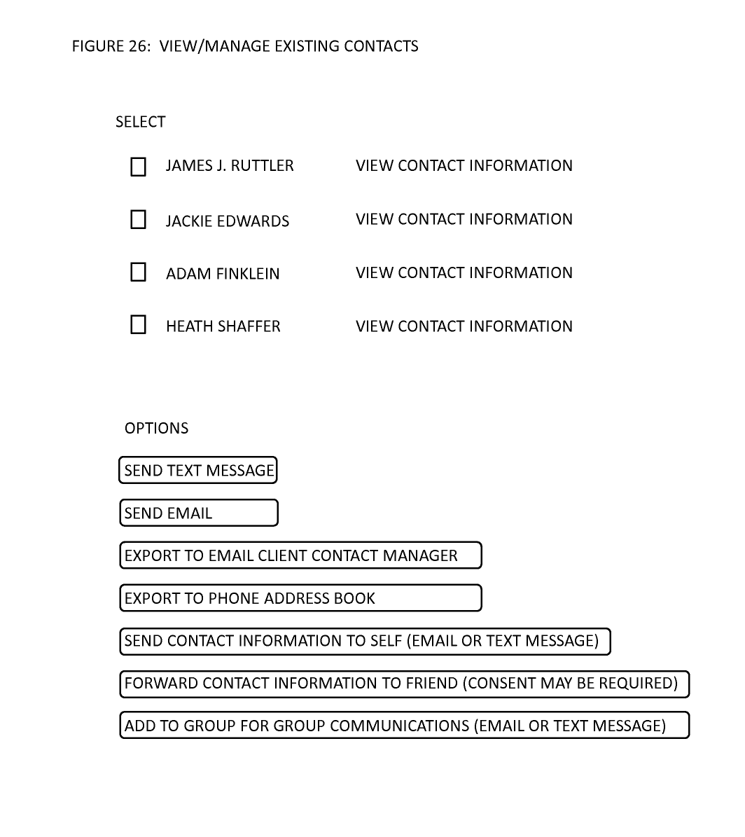

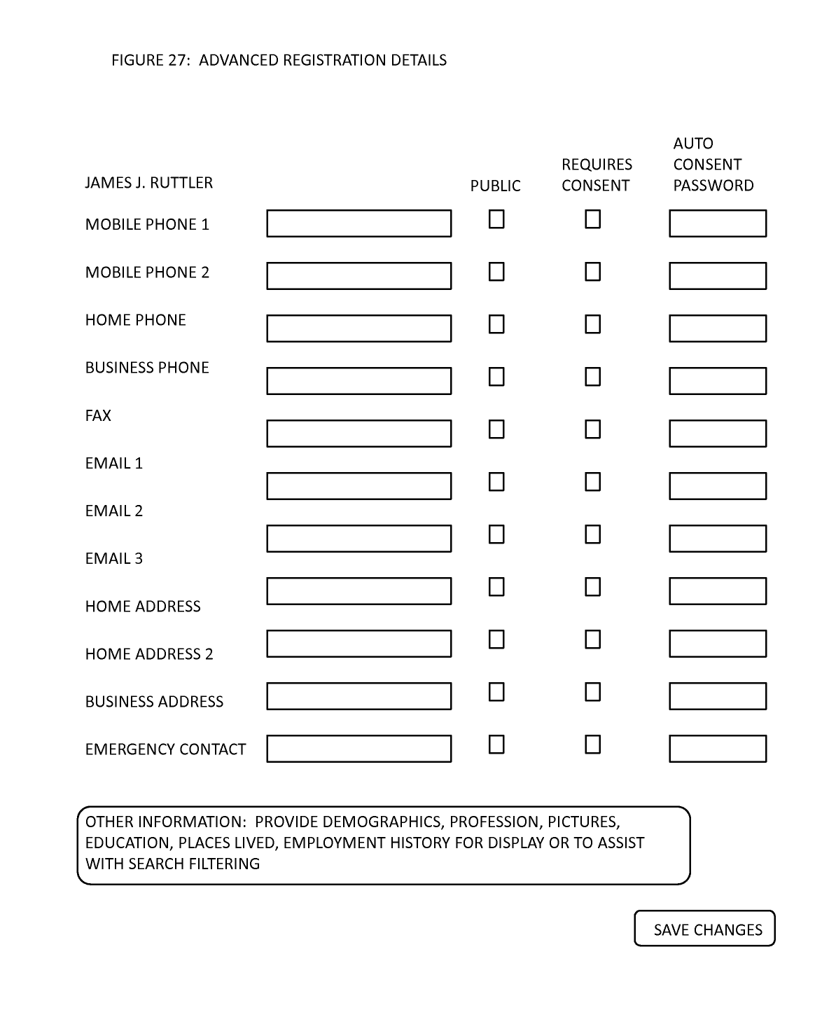

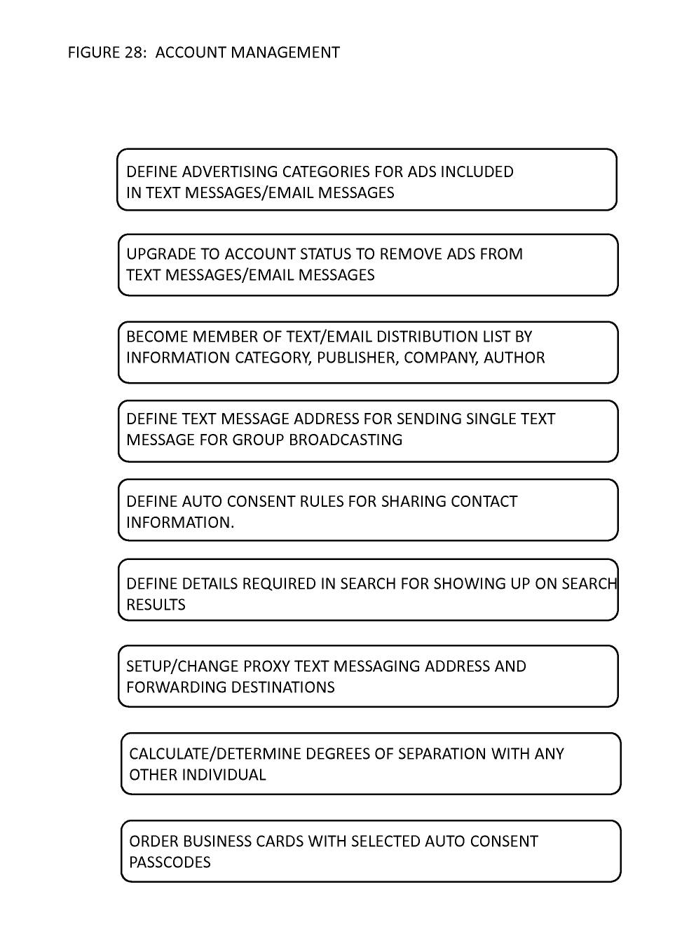

This invention relates generally to computers, and more specifically, to systems and methods for providing a mobile phone number exchange system. Specific details of certain embodiments of the invention are set forth in the following description and in FIGS. 1-28 and APPENDIX A to provide a thorough understanding of such embodiments. The present invention may have additional embodiments, may be practiced without one or more of the details described for any particular described embodiment, or may have any detail described for one particular embodiment practiced with any other detail described for another embodiment.

As an example of one embodiment of the invention, a first individual interested in discovering a mobile phone number of second individual accesses the software application over the internet. If the first individual does not have an account, the first individual is prompted to provide a name, city, state, mobile phone number, email, and password. No payment or other information is necessarily required. This information is then stored in a central database and the first individual is provided limited access to search the central database for the second individual's mobile phone number. If the first individual already has an account, the first individual is prompted to identify themselves using the previously selected password. Upon identification, the first individual is provided limited access to search the central database for the second individual's mobile phone number. For searching, the first individual enters the name of the second individual and the central database is queried for any similar matches. The name, city, and state of similar matches are displayed for the first individual to view, but the mobile phone number and email are not provided to the first individual. If the first individual recognizes one of the matches and desires to know the mobile phone number associated with a match, that match can be selected. Upon selection, the software application sends an email to the second individual informing that person that the first individual is requesting the second individual's mobile phone number and requesting consent for sharing the mobile phone number. If the second individual does not provide consent, then the first individual does not gain access to the second individual's mobile phone number. If the second individual provides consent, a text message containing the second individual's phone number is provided to the first individual's mobile phone number and a text message containing the first individual's mobile phone number is provided to the second individual's mobile phone number. Thereafter, the first individual is able to store the second individual's mobile phone number on his or her mobile phone and, likewise, the second individual is able to store the first individual's mobile phone number on his or her mobile phone. Upon searching, if the first individual does not recognize any of the matches, likely because the second individual has not previously accessed the software application, the first individual can provide a known email account for the second individual. In this case, the software application sends an email to the second individual using the email account informing that person that an undisclosed individual is requesting the second individual's mobile phone number and inviting the second individual to access the software application to provide his or her name, city, state, mobile phone number, email, and password. Upon doing so, the second individual is more specifically informed that the first individual is requesting the second individual's mobile phone number and requests consent for sharing the mobile phone number. The second individual can then decline or provide consent as set forth above. Alternatively, if the first individual does not recognize any of the matches and does not know an email account for the second individual, the software application can retain the request and notify the second user in the future if the second user eventually accesses the software application. Thereafter, a third individual interested in discovering a mobile phone number of first individual can access the software application over the internet. If the third individual does not have an account, the third individual is prompted to provide a name, city, state, mobile phone number, email, and password. No payment or other information is necessarily required. This information is then stored in a central database and the third individual is provided limited access to search the central database for the first individual's mobile phone number. If the third individual already has an account, the third individual is prompted to identify themselves using the previously selected password. Upon identification, the third individual is provided limited access to search the central database for the first individual's mobile phone number. For searching, the third individual enters the name of the first individual and the central database is queried for any similar matches. The name, city, and state of similar matches are displayed for the third individual to view, but the mobile phone number and email are not provided to the third individual. If the third individual recognizes one of the matches and desires to know the mobile phone number associated with a match, that match can be selected. Upon selection, the software application sends an email to the first individual informing that person that the third individual is requesting the first individual's mobile phone number and requesting consent for sharing the mobile phone number. If the first individual does not provide consent, then the third individual does not gain access to the first individual's mobile phone number. If the first individual provides consent, a text message containing the first individual's phone number is provided to the third individual's mobile phone number and a text message containing the third individual's mobile phone number is provided to the first individual's mobile phone number. Thereafter, the third individual is able to store the first individual's mobile phone number on his or her mobile phone and, likewise, the first individual is able to store the third individual's mobile phone number on his or her mobile phone. The third individual can likewise search for the mobile phone number of the second individual. Thus, this framework can be repeated for an infinite number of individuals all searching for each other's mobile phone numbers.

In one particular embodiment, previous consents granted for a given individual can be retained by the software application to permit/facilitate ease of access to lost mobile phone numbers, such as when a mobile phone is lost or exchanged.

In one particular embodiment, revenue is generated by including advertisements in the text messages having the desired mobile phone numbers therein. The advertisements can be targeted by categorical information provided by the individual, such as upon first accessing the software application.

In one particular embodiment, email addresses, instant messaging usernames, land-line phone numbers, websites, addresses, and any other contact information can be similarly shared and exchanged. Any information can be exchanged via text messaging, instant messaging, email, or web interface.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. A method comprising:
receiving a contact name from a requesting entity;
identifying the contact name in a data source;
obtaining permission to disclose contact information associated with the contact name with the requesting entity; and
upon receiving permission, disclosing the contact information associated with the contact name with the requesting entity,
wherein the method is performed by computer executable instructions embodied in computer readable media.
